(19) United States
(12) Patent Application Publication
(10) Pub. No.: US 2002/0167467 A1
(43) Pub. Date: Nov. 14, 2002

(54) Compensation method for improving color saturation and image quality of plasma display panel by adjusting the strength of input image signals

(76) Inventors: Shiuh-Bin Kao, Taipei (TW); Yi-Sheng Yu, Taipei (TW); Kuang-Lang Chen, Taipei (TW); Ching-Hui Lin, Taipei (TW)

Correspondence Address: BACON & THOMAS, PLLC, 625 SLATERS LANE, FOURTH FLOOR, ALEXANDRIA, VA, 22314

(21) Appl. No.: 09/859,400

(22) Filed: May 18, 2001

(30) Foreign Application Priority Data
Apr. 3, 2001 (TW) 090108033

(51) Int. Cl. G09G 3/28

(52) U.S. Cl. 345/60

(57) ABSTRACT

A compensation process for improving color saturation and image quality of a plasma display panel (PDP) comprises the steps of a) calculating the brightness of a visible light generated by environment light on PDP through performing a numeric operation according to a color mixing theory, and the corresponding light ought to be generated by each of red, green, and blue discharge cells of each of a plurality of pixels on the PDP sufficient to exclude the visible light generated by environment light on PDP; b) increasing or decreasing strength of input image signals of each of said red, green, and blue discharge cells in accordance with the result of calculation; and c) generating light from each of said red, green, and blue discharge cells to eliminate said visible light from causing an adverse effect on said PDP. This can reduce manufacturing cost without modifying the construction of PDP or performing an additional processing thereon.

### FIELD OF THE INVENTION

The present invention relates to plasma display panels and more particularly to a compensation method for improving color saturation and image quality of plasma display panel by adjusting the strength of input image signals.

### BACKGROUND OF THE INVENTION

A manufacturing process of a conventional alternating current discharge type plasma display panel (PDP) 10 is shown in FIG. 1. First, two different activation layers are formed on glass substrates 11 and 12 respectively. Then seal the peripheries of glass substrates 11 and 12 together. A mixed gas consisting of helium (He), neon (Ne), and xenon (Xe) (or argon (Ar)) having a predetermined mixing volume ratio is stored in a discharge space formed in between the glass substrates 11 and 12. A front plate 11 is defined as one of the glass substrates 11 and 12that facing viewers. A plurality of parallel spaced transparent electrodes 111, a plurality of parallel spaced bus electrodes 112, a dielectric layer 113, and a protection layer 114 are formed from the front plate 11 inwardly. Correspondingly, from rear plate 12 inwardly, a plurality of parallel spaced data electrodes 121, a dielectric layer 124, a plurality of parallel spaced ribs 122, and a uniform phosphor layer 123 are formed. When a voltage is applied on electrodes 111, 112, and 121, dielectric layers 113 and 124 will discharge in discharge cell 13 formed by adjacent spaced ribs 122. As a result, a ray having a desired color is emitted from phosphor layer 123.

Since the plurality of parallel spaced ribs 122 and a uniform phosphor layer 123 are formed on rear plate 12 when a ray from environment is lit on the PDP 10, it is possible for light diffused from spaced ribs 122 and uniform phosphor layer 123 on rear plate 12. As a result, the color saturation and image quality of PDP is degraded significantly when PDP 10 is exposed to a bright environment.

Conventionally, a number of improvements have been proposed to mitigate above problems. For example, NEC (Japan) implements a capsulated color filter technique. A filter 20 on front plate 11 is formed on each of corresponding red, green, and blue discharge cells 13 as shown in FIG. 2. With this, it is possible to filter out reflected light from discharge cells 13 caused by bright environment, thereby increasing color saturation of PDP. However, the manufacturing cost is increased significantly because the manufacturing process of filters 20 is complex. Another improvement technique is proposed by Plasmaco (Japan) in which circular polarizing filters are used for eliminating the adverse influence of bright environment. However, the brightness of PDP may be adversely affected since the transmissibility of such circular polarizing filters is low. Thus, such technique is undesirable.

In view of the above, such conventional improvements are disadvantageous since only filters are employed for eliminating reflection from discharge cells 13 caused by bright environment. Thus, it is desirable to provide a novel method for improving color saturation and image quality of PDP in order to overcome the above drawbacks of prior art.

### SUMMARY OF THE INVENTION

It is an object of the present invention to provide a compensation process for improving color saturation and image quality of a plasma display panel (PDP), the process comprising the steps of: a) calculating the brightness of a visible light generated by environment light on PDP through performing a numeric operation according to color mixing theory, and the corresponding light ought to be generated by each of red, green, and blue discharge cells of each of a plurality of pixels on the PDP to exclude the visible light generated by environment light; b) increasing or decreasing strength of input image signals of each of the red, green, and blue discharge cells in accordance with the result of calculation; and c) generating light from each of the red, green, and blue discharge cells to eliminate the visible light from causing an adverse effect on the PDP.

It is another object of the present invention to provide a number of environment light modes (e.g., strong light mode, room light mode, exhibition light mode, etc.) preset in control circuit of PDP for user to select an appropriate light mode depending on the real environment of PDP and to perform a compensation on color saturation of PDP effectively excluding the visible light generated by environment light from the generated light of each of the red, green, and blue discharge cells, thereby eliminating an adverse effect of the environment light on the PDP.

The above and other objects, features and advantages of the present invention will become apparent from the following detailed description taken with the accompanying drawings.

### BRIEF DESCRIPTION OF THE DRAWINGS

FIG. 1 is a sectional view of a conventional alternating current discharge type plasma display panel (PDP);

FIG. 2 is a sectional view of another conventional technique utilized by NEC (Japan) illustrating the implementation of capsulated color filters;

FIG. 3 is a block diagram illustrating the processes of a first preferred embodiment of compensation method according to the invention;

FIG. 4 is a graph illustrating the effect before and after implementing the compensation of the invention on color saturation of PDP, while first 128 gray scales of respective color of input image are sampled and the threshold value of respective color is set as 20 in a bright environment.

FIG. 5 is a block diagram illustrating the processes of a second preferred embodiment of compensation method according to the invention; and

FIG. 6 is a block diagram illustrating the processes of a third preferred embodiment of compensation method according to the invention.

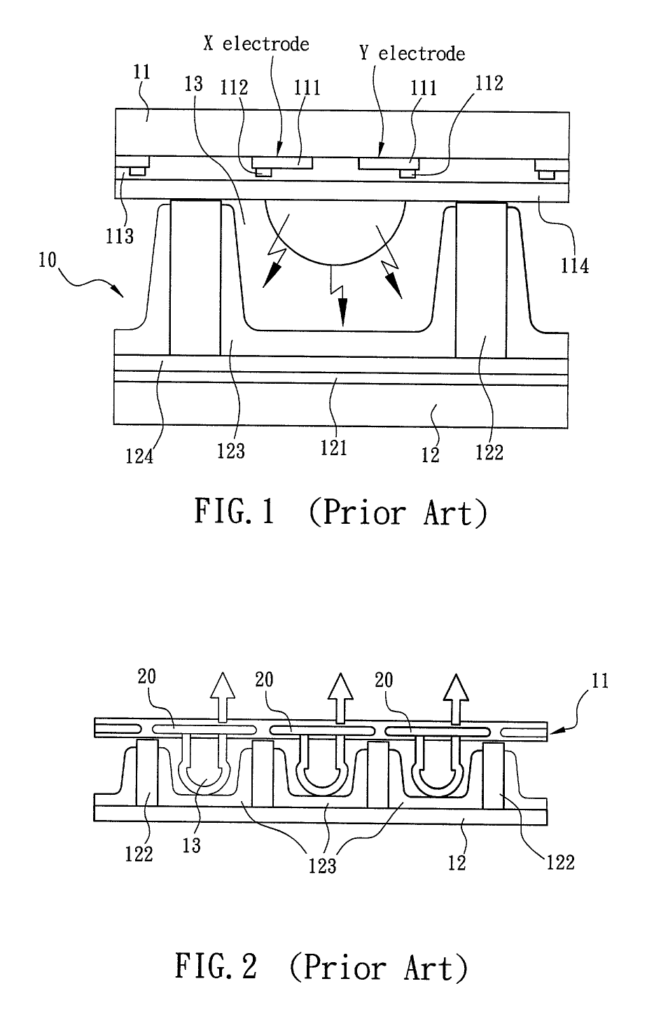

### DETAILED DESCRIPTION OF THE PREFERRED EMBODIMENTS

Typically, an image shown on a well known PDP consists of a plurality of pixels. Note that the number of pixels is determined by the resolution of PDP. A pixel consists of three discharge cells capable of emitting red, green, and blue lights respectively. Hence, the color of a pixel of image shown on PDP is a mixture of red, green and blue lights emitted by respective discharge cell. For example, a, b, and c are gray scales of red, green and blue lights emitted by respective discharge cell of each pixel of PDP. R_{cell}, G_{cell}, and B_{cell} are brightness of respective gray scale in phosphor layer of discharge cells corresponding to each pixel. In a dark environment (i.e., not influenced by light), the brightness of respective red, green, and blue discharge cell may be expressed by equations (1), (2) and (3) below:

brightness of red discharge cell=aR_{cell} (1),

brightness of green discharge cell=bG_{cell} (2), and

brightness of blue discharge cell=cB_{cell} (3)

Hence, Image_{Dark} of each pixel observed in the dark environment is expressed by equation (4) below:

$$\begin{matrix}{Image}_{Dark} = brightness of red discharge cell + \\ brightness of green discharge cell + \\ brightness of blue discharge cell \\ = {aR}_{cell} + {bG}_{cell} + {cB}_{cell}\end{matrix} \qquad ( 4 )$$

Since a plurality of parallel spaced ribs and a uniform phosphor layer are formed on rear plate when a visible light from environment is lit on the PDP, a diffused light is thus generated. Hence, an additional visible light W is generated on PDP. One aspect of the invention is to eliminate the adverse effect of such visible light W on color saturation and image quality of PDP. Thus, laws of color matching proposed by Grassman is adopted in which the additional visible light W, which can be generated by red, green and blue discharge cells, may be expressed by the following equation (5)

W=αR_{cell}+βG_{cell}+γB_{cell} (5)

Wherein R_{cell}, G_{cell}, and B_{cell} are brightness of gray scale of red, green and blue discharge cells respectively and α, β and γ are the number of gray scales of red, green and blue discharge cells respectively.

Since the visible light W diffused from spaced ribs and phosphor layer may degrade significantly the color saturation and image quality of PDP when PDP is exposed to a bright environment. The invention utilizes the control circuit of PDP for increasing or decreasing the strength of input image signals (or input voltage) of each discharge cell to exclude the effect of the additional visible light W from the color generated by red, green and blue discharge cells while showing image on PDP. As a result, the adverse effect of the visible light W on PDP is completely eliminated, thereby improving the color saturation and image quality of PDP.

In the first embodiment of the invention, the additional visible light W on PDP generated by environment light may be prepared by a predetermined mixing ratio of red, green and blue lights. In a bright environment, the visible light W diffused from PDP may be expressed by above equation (5). The Image_{Bright} observed in the bright environment is expressed by equation (6) below which is an addition of equations (4) and (5):

$$\begin{matrix}{Image}_{Bright} = {Image}_{Dark} + W \\ = {aR}_{cell} + {bG}_{cell} + {cB}_{cell} + α {R}_{cell} + β {G}_{cell} + γ {B}_{cell}\end{matrix} \qquad ( 6 )$$

wherein αR_{cell}+βG_{cell}+γB_{cell} is the adverse effect of the additional visible light W on PDP, i.e. the main factor of the degradation of color saturation and image quality of PDP.

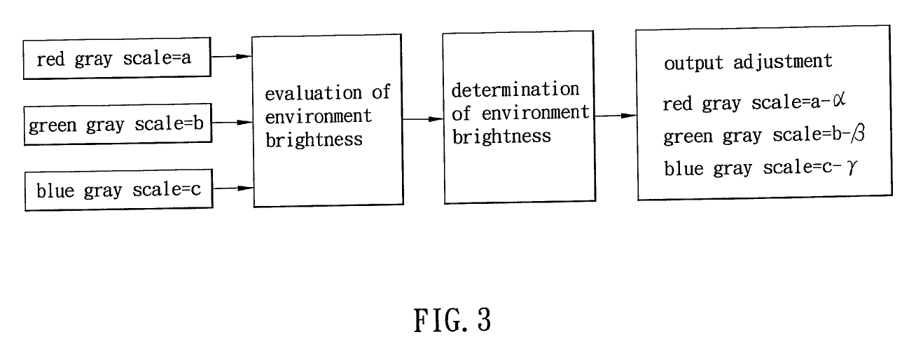

In the embodiment shown in FIG. 3, it is required to first calculate the affecting degree of the environment light (i.e., the additional visible light W) in compensating color saturation of PDP in a bright environment. As such, prior to image output it is possible to adjust the strength of input image signals of each discharge cell by the control circuit. Thus, the brightness of the generated color may be expressed by equations (7), (8) and (9) with the exclusion of visible light W:

brightness of compensated red discharge cell=aR_{cell}−αR_{cell} (7),

brightness of compensated green discharge cell=bG_{cell}−G_{cell} (8), and

brightness of compensated blue discharge cell=cB_{cell}−γB_{cell} (9)

For avoiding a negative value from generating by each discharge cell when an operation is performed on each of above equations (7) to (9), a threshold value of respective color (e.g., threshold value of red=Th_{Red}, threshold value of green=Th_{Green}, or threshold value of blue=Th_{Blue}) is selected. Hence, it is possible to determine whether the gray scale of respective color of input image (e.g., red gray scale is a, green gray scale is b, or blue gray scale is c) is larger than, equal to, or smaller than the threshold value of the corresponding color. Thereafter, prior to outputting image on PDP the invention can activate the control circuit to perform an operation on each of above equations (7) to (9), thereby adjusting the strength of input image signals of each discharge cell. Hence, after the compensation on image of PDP by the invention, the brightness of pixel may be expressed by equation (10) below:

brightness of pixel after compensation=brightness of red discharge cell after compensation+brightness of green discharge cell after compensation+brightness of blue discharge cell after compensation+W

$$\begin{matrix}= {aR}_{cell} - α {R}_{cell} + {bG}_{cell} - β {G}_{cell} + {cB}_{cell} - γ {B}_{cell} + \\ ( α {R}_{cell} + β {G}_{cell} + γ {B}_{cell} ) \\ = {aR}_{cell} + {bG}_{cell} + c {B}_{cell}\end{matrix} \qquad ( 10 )$$

As stated above, since the brightness of the visible light W may be expressed as the addition of the brightness of color generated by red, green, and blue discharge cells R_{cell}, G_{cell} and B_{cell}, i.e., W=αR_{cell}+βG_{cell}+γB_{cell}. It is apparent from equation (10) that the adverse effect of the visible light W on PDP is completely eliminated.

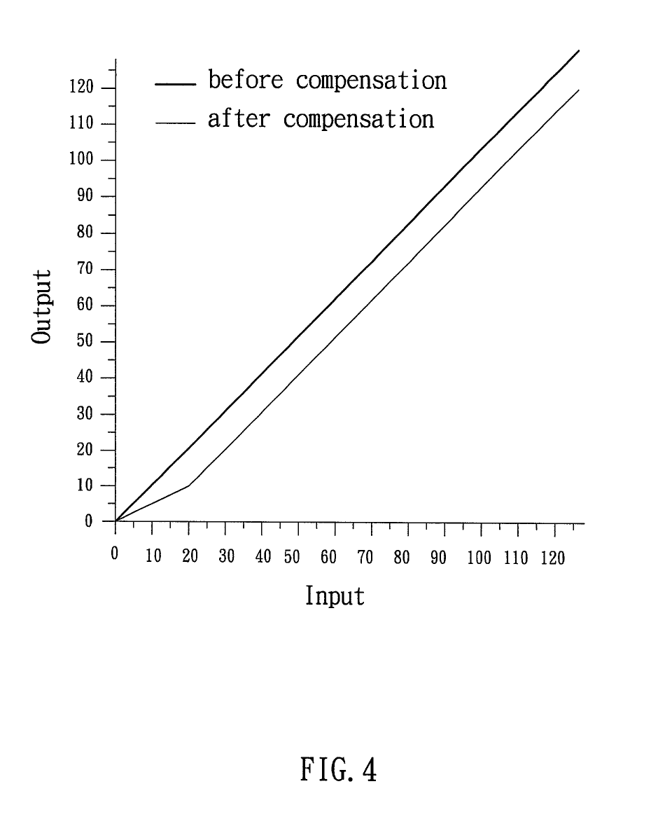

Referring to FIG. 4, first 128 gray scales of respective color of input image are sampled and the threshold value of respective color is set as 20. In a bright environment, a compensation on color saturation of PDP is performed by the invention. It is apparent that in the low gray scale region, the negative values of equations (7) to (9) are avoided. Most importantly, the adverse effect of the bright environment light on PDP is completely eliminated. In the embodiment, if gray scale of each color of input image (e.g., red gray scale is a, green gray scale is b, and blue gray scale is c) is smaller than the threshold value of respective color, the brightness of pixel after compensation may be expressed by equation (11) below:

brightness of pixel after compensation=brightness of red discharge cell after compensation+brightness of green discharge cell after compensation+brightness of blue discharge cell after compensation+W

$$\begin{matrix}= a ( α / {Th}_{Red} ) {R}_{cell} + b ( β / {Th}_{Green} ) {G}_{cell} + c ( γ / {Th}_{Blue} ) {B}_{cell} + \\ ( α {R}_{cell} + β {G}_{cell} + γ {B}_{cell} )\end{matrix} \qquad ( 11 )$$

Adjust the strength of input image signals of respective discharge cell based on the ratio between gray scale of each color of input image and default threshold gray scale. As a result, the negative values are avoided. Further, the adverse effect of the bright environment light on PDP is completely eliminated.

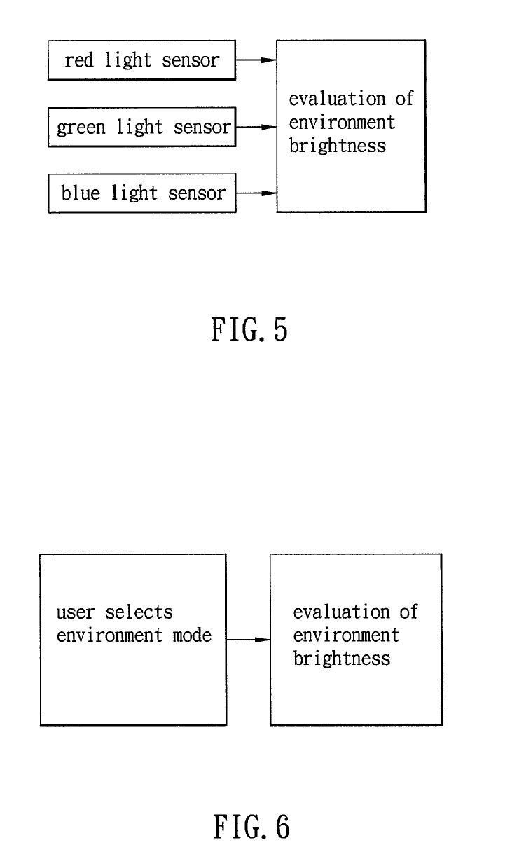

Referring to FIG. 5, there is shown a second embodiment of the invention wherein an active compensation on color saturation is performed in a bright environment. A light sensor is used to detect environment light. The detected values are processed in order to evaluate the effect of environment light on PDP. Finally, a compensation on color saturation of PDP may be performed accordingly.

Referring to FIG. 6, there is shown a third embodiment of the invention wherein an inactive compensation on color saturation is performed in a bright environment. A number of environment light modes (e.g., strong light mode, room light mode, exhibition light mode, etc.) are provided for user selection when control circuit of PDP is activated. With this, user may select an appropriate light mode depending on the real environment of PDP. Similarly, a compensation on color saturation of PDP may be performed accordingly.

In brief, the invention can adjust the brightness of the generated red, green, or blue light by increasing or decreasing the strength of input image signals of respective discharge cell of each pixel. Hence, the adverse effect of environment light on color saturation of PDP is completely eliminated. Most importantly, there is no need to modify the construction of PDP or perform an additional processing thereon. This is simple, resulting in a reduction in the manufacturing cost.

While the invention has been described by means of specific embodiments, numerous modifications and variations could be made thereto by those skilled in the art without departing from the scope and spirit of the invention set forth in the claims.

What is claimed is:

1. A compensation process for improving color saturation and image quality of a plasma display panel (PDP), said process comprising the steps of:
a) calculating the brightness of a visible light generated by environment light on PDP through performing a numeric operation according to a color mixing theory, and the corresponding light ought to be generated by each of red, green, and blue discharge cells of each of a plurality of pixels on the PDP sufficient to exclude the visible light generated by environment light on PDP;
b) increasing or decreasing strength of input image signals of each of said red, green, and blue discharge cells in accordance with the result of calculation; and
c) generating light from each of said red, green, and blue discharge cells to eliminate said visible light from causing an adverse effect on said PDP.

2. The compensation process of claim 1, wherein said visible light is expressed by an addition of a value of said red light, a value of said green light, and a value of said blue light respectively generated by each of red, green, and blue discharge cells of each of a plurality of pixels on the PDP through said numeric operation according to said color mixing theory.

3. The compensation process of claim 1, wherein said visible light is expressed by an addition of two values of different color lights generated respectively by two different discharge cells of each of a plurality of pixels on the PDP through said numeric operation according to said color mixing theory.

4. The compensation process of claim 2 or 3, wherein said values are used for adjusting strength of said input image signals of each of said red, green, and blue discharge cells so that an adverse effect of said visible light on PDP is eliminated by said generated light having said values.

5. The compensation process of claim 4, further comprising a light sensor for detecting said environment light so as to calculate the brightness of light generated from each of said red, green, and blue discharge cells of each pixel on said PDP through performing said numeric operation.

6. The compensation process of claim 4, further comprising the step of providing a plurality of user selectable environment light modes, which is selected to activate a control circuit in said PDP corresponding to a real environment of said PDP, to eliminate said visible light from causing an adverse effect on color saturation of said PDP.

7. The compensation process of claim 4, further comprising the steps of setting a threshold gray scale of each of red, green, and blue lights generated from each of said red, green, and blue discharge cells of each pixel on said PDP; and detecting and determining whether said gray scale of each of red, green, and blue lights of an input image is larger than or equal to said threshold gray scale of each of red, green, and blue lights, whereby if said determination is positive a control circuit in said PDP is operative to adjust said strength of said input image signals of each of said red, green, and blue discharge cells so that said adverse effect of said visible light on PDP is eliminated by said generated light.

8. The compensation process of claim 4, further comprising the steps of detecting and determining whether said gray scale of each of red, green, and blue lights of an input image is smaller than said threshold gray scale of each of red, green, and blue lights, whereby if said determination is positive a control circuit in said PDP is operative to adjust said strength of said input image signals of each of said red, green, and blue discharge cells so that negative values are avoided from generating by each of said red, green, and blue discharge cells.
